(19) United States
(12) Patent Application Publication
(10) Pub. No.: US 2013/0226605 A1
(43) Pub. Date: Aug. 29, 2013

(54) SYSTEM AND METHOD FOR DELTA CHECKING OF BIOLOGICAL SAMPLES

(71) Applicant: UNIVERSITY OF LOUISVILLE RESEARCH FOUNDATION, INC., (US)

(72) Inventors: James J. Miller, Louisville, KY (US); Thomas Kampfrath, Louisville, KY (US)

(73) Assignee: UNIVERSITY OF LOUISVILLE RESEARCH FOUNDATION, INC., Louisville, KY (US)

(21) Appl. No.: 13/771,966

(22) Filed: Feb. 20, 2013

Related U.S. Application Data
(60) Provisional application No. 61/602,810, filed on Feb. 24, 2012.

(51) Int. Cl. G06F 19/00

(52) U.S. Cl. CPC G06F 19/34
USPC 705/2

(57) ABSTRACT

Methods of the invention automatically determine analytes and delta thresholds to use in delta checking patient data. The analytes and thresholds are determine from a populating specific set of patient data. Variance in analytes for multiple patient samples is determined. In additional, variance in intentionally mismatched patient samples is determined. The best analytes to differentiate between patients are determined along with delta thresholds. Preferred embodiments conduct evaluation with a multivariate delta threshold determination for ongoing testing of results from the patient. Preferred software provides an interactive interface that allows a user to set a number of flags that can be handled per a predetermined time period, and automatically adjusts the delta threshold to that number of flags.

### PRIORITY CLAIM AND REFERENCE TO RELATED APPLICATION

The application claims priority under 35 U.S.C. §119 from prior provisional application Ser. No. 61/602,810, which was filed Feb. 24, 2012.

### FIELD

A field of the invention is medical sample testing. Example applications of the invention include systems and methods embodied in computer code on a fixed medium for testing the integrity of biological samples. A particular application for a system in a clinical chemistry or hematology laboratory for testing the integrity of blood samples.

### Acronyms and Symbols

The following list provides a convenient reference list acronyms and symbols used in the sections that follow:

Alb Albumin

ALP Alkaline phosphatase

ALT Alanine aminotransferase

AST Aspartate aminotransferase

BMP Basic Metabolic Panel

BUN Blood urea nitrogen

Ca Calcium

CBC Complete Blood Counts

Cl Chloride

CMP Comprehensive Metabolic Panel

CO₂ Carbon Dioxide

Crea Creatinine

CVg Coefficient of variation (interindividual)

CVi Coefficient of variation (intraindividual)

DCL Delta Check Limit

EFF Efficiency (average of SENS and SPEC)

FN False Negative

FP False Positive

Glu Glucose

II Index of Individuality (CVi/CVg)

IV Intravenous

K Potassium

LIS Laboratory Information System

LR− Likelihood Ratio of Neg Test ((1-SENS)/SPEC)

LR+ Likelihood Ratio of Pos Test (SENS/(1-SPEC)

MCV Mean (red blood cell) corpuscular volume

MD Multivariate Delta

Na Sodium

PV− Predictive Value of Neg Test(TN/(TN+FN))

PV+ Predictive Value of Pos Test(TP/(TP+FP))

RDW Red cell distribution width

TBIL Total Bilirubin

TN True Negative

TP True Positive

TotP Total protein

### BACKGROUND

Delta checking is a process used by most clinical chemistry and hematology sections of hospital based clinical laboratories to help insure the integrity of blood samples. Maintaining integrity includes proper labeling with the name of the patient from whom the sample was collected, freedom from contamination of the sample with IV fluid, freedom from hemolysis due to difficulty during sample collection or improper handling during processing, and turbidity from contamination with IV fluid containing lipids or insufficient centrifugation during sample processing. Some clinical laboratories employ delta checking for other reasons such as to monitor for clinically significant changes in a patient and detecting differences in results produced by two different analytical techniques. However, present delta checking does not function well for these other purposes.

In a typical prior system, a default setting for delta checking is “off”. Clinical chemistry sections of the laboratory typically turn on delta decking for 2-5 of the 8 analytes on a BMP. The 8 analytes on a BMP include Na, K, Cl, CO₂, Glu, BUN, Crea, and Ca. The 8 analytes on the BMP are also included in a CMP, which also includes TotP, Alb, TBIL, ALP, AST, and ALT.

Few laboratories turn on delta checks for the additional analytes on a CMP, but these analytes, especially the enzymes (ALP, AST, and ALT), may be helpful for investigating delta check flags. Hematology sections of the laboratory typically turn on delta checking for MCV and RDW.

The delta checking process is accomplished by the LIS or by a user programmable interface between laboratory instruments and the LIS called Middleware. In the process, the LIS or middleware compares the current results on a patient's sample with the previous results for the same analyte on that patient. If the results vary by more than a certain amount, the DCL, a Delta Check flag is attached to that result and the technologist will attempt to determine whether the change is likely to be due to a change in the patient's condition or due to misidentification (i.e., from a different patient and mislabeled) or other problems with the integrity of the sample. This evaluation includes checking previous results on several samples from the patient, correlating the changes in several analytes, checking to see if there were Delta Check flags in other sections of the laboratory, notifying the Blood Bank that specimens from that patient may be mislabeled, calling the ward to inquire about changes in the patient's condition and how the sample was collected. If the technologist concludes that the sample is likely to be misidentified or its integrity is otherwise compromised (contaminated, hemolyzed, etc.), a recollection will be requested. This evaluation may take anywhere between 1 and 10 minutes or more, averaging about 5 minutes per specimen with one or more Delta Check flags. This will delay reporting of the results, especially if recollection is necessary.

Turning on Delta Checking involves selecting a DCL for the analyte, selecting 1 of 4 types of change (absolute change, rate of absolute change, percent change, or rate of percent change), and the maximum time interval between the current and previous sample. Most laboratories choose DCL from the literature, use absolute change, and a maximum of 1 to 7 days between samples for these parameters. The parameters chosen may not be optimum for the laboratory's patient population. Laboratories currently have no tools better than trial and error to improve their delta check procedures. This is a daunting task. There are 4 types of deltas and 255 combinations of analytes on a BMP, thus the lab must choose between 1020 different delta check procedures, not including the variable of maximum time between specimens.

Detection of misidentified specimens is the most common use of Delta Checking. The theory is that the variation in a patient's results over time is less than the variation between different patients. The variation in a patient's results is called the intraindividual variation, expressed as a CVi. The variation among the population or group is called the CVg. The ratio CVi/CVg is called the index of individuality (II). The lower the II for an analyte, the better the Delta Checking that analyte is for detecting whether the sample is from the correct patient or from another patient. The analytes most commonly Delta Checked are analytes with relatively low II. CVi and CVg data are available in the literature for most analytes and the II can be calculated. These literature values for II have not had great success in reducing the number of false alarms or making Delta Checking more useful in practical situations.

Iizuka et al., reports the use of a complex multivariate delta check for pre-selected analytes that were commonly used in a specific hospital in Japan. Iizuka et al., “Multivariate Delta Check Method for Detecting SpecimenMix-Up,” Clin. Chem. 28/11, 2244-48 (1982). The three analytes used are not used by many laboratories in practice, and the technique is not believed to have been adopted. The three analytes considered are used by very few laboratories for delta checking (cholesterol) or even measure (zinc sulfate turbidity test (archaic) and cholinesterase (performed only in reference laboratories). Lacher discussed and ranked traditional delta checks for 20 different analytes on a set of patients. Lacher, “Relationship between Delta Checks for Selected Chemistry Tests,” Clin. Chem. 36/12, 2134-36 (1990). Lacher discusses the individual correlations in directions of correlated delta checks as providing measures of confidence.

Despite the significant amount of research that has been conducted, the ability to accurately identify actual specimen handling or laboratory errors continues to prove difficult or expensive in a laboratory setting. Delta checks remain out of favor in practice because of the current high rate of false positives.

The high false alarm rate causes Delta Checks to be ignored in practice. Re-testing a high percentage of samples with low specificity Delta Checks is counterproductive and expensive. For these and other reasons, unfortunately, Delta Checking often does not work well in practice. Its use in practice remains limited, and research has been devoted to finding alternative processes.

### SUMMARY OF THE INVENTION

The present inventors have identified some causes of the poor performance of Delta Checking in current practice. One problem is that literature values are typically based upon healthy persons and are not optimized for hospital population specific delta check parameters. Another problem recognized by the inventors is that patients' clinical conditions are often changing rapidly (getting worse or getting better), especially in a tertiary care hospital. In such a situation, DCL must be set rather high to keep from flagging too many patients whose clinical condition is changing. On the other hand, the higher the DCL, the greater the possibility of not recognizing some misidentified samples. In practice, the majority of samples with Delta Check flags are deemed to be properly labeled. Delta Checking methods of the invention can be both more sensitive (ability to detect misidentified samples) and more specific (fewer false positive Delta Check flags). Embodiments of the invention can improve patient safety and decrease the labor necessary to investigate the reason for a Delta Check flag.

Preferred methods of the invention automatically determine analytes and delta thresholds to use in delta checking patient data. The analytes and thresholds are determine from a population specific set of patient data. Variance in analytes for multiple patient samples is determined. In addition, variance in intentionally mismatched patient samples is determined. The best analytes to differentiate between patients are determined along with delta thresholds. Preferred embodiments conduct evaluation with a multivariate delta threshold determination for ongoing testing of results from the patient population.

### BRIEF DESCRIPTION OF THE DRAWINGS

FIG. 1 shows a preferred embodiment method of the invention that can be implemented by computer code on a non-transient medium;

FIGS. 2A and 2B respectively illustrate exemplary multivariate deltas for two and three analytes; and

FIG. 3 plots receiver-operating characteristic curves (ROC) based upon sensitivity and specificity and which were obtained from testing.

### DETAILED DESCRIPTION OF THE PREFERRED EMBODIMENTS

Embodiments of the invention provide systems, e.g., LIS with robust delta checking method that analyzes and obtains parameters to automatically select population specific parameters that can be use to for and conduct a multivariate delta check or a modified univariate check. Preferred methods utilize a multivariat delta check method of the invention. Preferred automatic delta check parameter selection algorithms and multivariate delta checking algorithms are implemented from computer code on a non-transient computer readable medium. Preferred embodiments provide multivariate delta check analysis and demonstrate significantly better results than state of the art systems including traditional delta checking. Preferred systems can also differentiate and flag samples as possibly belonging to different people.

Embodiments of the invention provide a calculation of II and/or additional diagnostic statistical parameters from the results on hospitalized patients or other specific populations, which can allow laboratories to more rationally select the analytes to Delta Check and the optimum delta check parameters. The index of individuality (II) from the literature is compared with the II calculated from hospitalized patients is found in the test data below. The testing demonstrates that methods of the invention that provide for analysis of a specific population to select analytes to be delta checked based on actual patient data is more effective than using generalized values for II found in the literature.

Preferred methods of the invention determine optimized delta checking parameters for traditional delta checking procedures and include a multivariate delta check that determines the distance between two points in n-space represented by the results for the two specimens, where n is the number of dimensions with a dimension for each analyte. In a preferred embodiment, the covariation is also calculated for two or more related analytes (for example, BUN and Crea and their ratio; anion gap=Na−Cl−CO₂; calculated osmolality=2Na+Glu/18+BUN/2.8). The multivariate data and covariate data are used to determine likelihood of misidentified, compromised, or contaminated samples.

Preferred methods of the invention are able to efficiently detect random specimen errors. Such errors can arise from short sample aspiration, mislabeled cups or samples, an incorrect patient draw, problems in analysis and clerical errors. With proper delta check parameters determined by the methods of the invention, false flags are reduced and delta check results have a higher confidence level that can be uniquely adapted to a specific laboratory or other concern.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale. The following methods are preferably executed by a laboratory information system, middleware, or an interfaced stand alone computer and are executed from code stored on a non-transient computer readable medium.

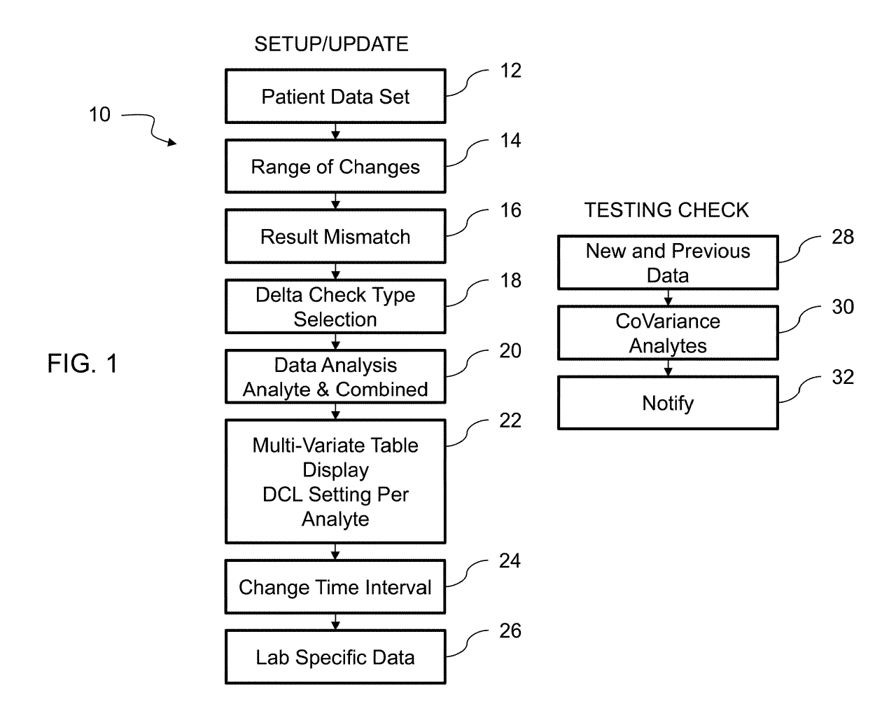

FIG. 1 illustrates a preferred method 10 for delta checking biological sample. The method 10 of FIG. 1 is implemented via computer code stored on a non-transient medium. Preferably, the code is stored or accessible by a computer device including a processer. Preferably, the computer device is configured to communicate with other devices via electronic data transfer. Example methods of data transfer include network communications via local or wide area networks, through secure or open communications, wired or wireless communications, or other methods of electronic data transfer.

Electronic patient data is received 12 by such methods. At least an initial data set is assumed to be correctly identified and free of interferences and contamination. The initial patient data can be received, for example, through a computer interface or report file. The data can be received from user's LIS. The input data can also be obtained via a number of techniques, including LIS reports and manual entry, database matching of codes to obtained data, and the like.

Software and methods of the invention incorporate, through setup, Delta check limits (DCL) should be determined based on the individual laboratory/ordering unit results derived from the LIS rather than DCL derived from the literature. In preferred embodiments, the software can input LIS data from a Microsoft®Excel® spreadsheet, providing a simple method to conduct a set up. A user can then select an unlimited number of analytes of interest to be included in the delta check equation. The delta check time frame can be customized for the lab. Users can select the number of flags (increasing number increases the sensitivity) according to the individual needs or goals. The software then determines the optimum type of Delta Check, the analytes, and the DCL for traditional Delta Checks and combines these into an MDC DCL to achieve the sensitivity, specificity and efficiency desired by the user. The user can choose to use the optimized and modified traditional Delta Check calculation that uses automatically determined and population-specific parameters determined by a method of the invention or the MDC method of the invention with the automatically determined and population specific parameters depending on the capabilities of their LIS and/or middleware. Typical LISs have traditional, univariate Delta Check capabilities, but the ability to use the Multivariate Delta Check would have to be programmed by the LIS vendor. The Multivariate Delta Check can be programmed into middleware, but not all labs have middleware. In embodiments of the invention where the traditional Delta Check is used, the Delta Check is modified by automatic identification and selection of optimum parameters based upon population specific data. The output can be directly linked into a Delta Check, imported, or the user can enter automatically determined and outputted or displayed parameters into existing LIS or middleware.

Typical received data will include a patient's BMP or CMP results. Other test results that could be included, but not limited to, magnesium, uric acid, phosphorus, cholesterol and other lipid components, such as low density lipoprotein cholesterol and high density cholesterol, iron, and other enzymes, such as lactate dehydrogenase, creatine kinase, and gamma-glutamyltransferase. These additional tests are usually not assayed frequently enough to be useful in Delta Checking, but optimized DCL can still be determined for the purpose of further investigation of Delta Check flags generated on BMP and CMP results. In addition, all examples given for BMP apply to the various tests on Complete Blood Counts (CBC), which would be analyzed separately since the sample types for BMP and CBC differ. The tests included in the data would depend on a facility's test menu and the choice of the user. Facilities that serve predominantly outpatients, for example, clinics, may not find Delta Checking for the purpose of identifying mislabeled specimens useful because two samples from the same patient are likely to be drawn weeks or months apart.

In a preferred embodiment, patient BMP, CMP, CBC, or other results are assumed to be correctly identified. For simplicity the preferred embodiments will be discussed with respect to BMP, but the same process would be used for other tests or panels. The BMP results can be results from a period of several days or longer. The range of changes 14 in each analyte is determined. The program then mismatches 16 the results to determine the range of changes in each analyte when the results are not from the same patient. This generates a set of misidentified samples by intentionally pairing results from two different patients.

For each analyte individually, the method then determines which delta check type 18 (absolute change, percent change, rate of absolute change, or rate of percent change) best differentiates correctly identified and misidentified samples for that analyte. This can be based upon predetermined information that is provided to the software from studies. User input can also be supported to select a type of delta check, and parameters. For example, a certain number of values can be designated as trusted to be accepted first. “Live data” has the disadvantage that it will contain some unknown number of misidentified samples. However, any recognized misidentified samples would have had a recollection requested and would not remain in the data set. The Delta Check type and any other parameters can be input by the user as an override, which allows the user to determine the performance of a current Delta Check procedure. Preferred embodiments however, automatically analyze the user's patient data to determine the best Delta. Check procedure using the traditional Delta Check and the best traditional Delta Check parameters are fed into the Multivariate Delta Check equation. The Multivariate Delta Check performs better than the traditional Delta Check, but some users may not be able to use the Multivariate Delta Check with their current information systems. The automatic analysis of the patient data and automatic selection of Delta Check parameters provides a modified method and system when the MDC is not used.

Data analysis 20 is thus conducted on the data set irrespective of whether a modified DC or MDC will be used. The analysis includes using the optimum delta check type for each analyte that was determined in 18. The analysis 20 then calculates the SENS, SPEC, EFF, PV+, PV−, LR+, and LR− for each analyte alone and in all possible combinations (n=255 for the 8 analytes included in a BMP).

The system displays 22, in a user convenient format, a table of the most efficient delta check combinations to the user along with the traditional DCL, the Multivariate DCL (according to the formula below) and statistical parameters for each, allowing a user to enter the most efficient delta check type, analytes, and DCL (modified traditional or multivariate) into their LIS. The Multivariate Delta (MD) is defined as

MD=\sqrt{(analyte1₂−analyte1₁)²+(analyte2₂−analyte2₁)²+ . . .} Equation 1

Where analyte1, analyte2, etc. are the results for several analytes on the same sample and subscripts 1 and 2 are the results on two consecutive samples from the same patient.

This MD is the distance between two points in n-space represented by the results for the two specimens, where n is the number of dimensions with a dimension for each analyte. For example, the number of analytes combined could be 8, which corresponds to the analytes on a Basic Metabolic Panel (BMP including Na, K, Cl, CO2, Glu, BUN, Crea, and Ca). The method has been tested with these 8 analytes.

In an alternate embodiment, the MD equation normalizes each analyte by division by the standard deviation of the reference range for that analyte. This makes the contribution of each analyte to the multivariate MD of similar magnitude.

$$MD = \sqrt{\frac{{( analyte {1}_{2} - analyte {1}_{1} )}^{2 }}{SD - {RR}_{1}} + \frac{{( analyte {2}_{2} - analyte {2}_{1} )}^{2}}{SD - {RR}_{2 }} + …} \qquad Equation 2$$

Then, automatically selecting and using the most efficient delta check parameters (with any individual user overrides accepted), the method evaluates 24 the impact of changing the maximum time interval between the current and previous result (1, 2, 3, or more days). The longer the time interval, the greater the number of Delta Check flags, but the longer the time interval, the more likely a misidentified specimen will be detected.

Users enter additional lab specific data. This data can include, for example, the approximate number of BMP (or other) tests performed per day and the approximate average time a technologist spends investigating delta check flags. From this, the software can calculate the number of daily delta check flags and total technologist time needed to investigate the flagged specimens for a specific lab that is using the software and method of the invention.

Processing of data can be conducted after an initial set up period, or if the system was given values obtained from a comparable data step. In FIG. 1, an initial set up for a lab or other concern using software that is carrying out a method of the invention would typically conduct steps 12-26, only once to determine optimum delta check parameters. The “set-up” steps can be repeated infrequently when there has been a change in analytical methodology or a substantial change in the laboratory's patient population.

The initial setup steps can also be repeated for other analytes. For example, another lab or concern or section of a lab or group of technicians could also utilize the additional 6 analytes on a Comprehensive Metabolic Panel (CMP), cholesterol, magnesium, and the various components of a Complete Blood Count (CBC). Methods of the invention are not limited to such particular panels, however, and will work with any patient data that includes a reasonable number of individual analyte components.

When a setup is complete, steps are conducted in an ongoing manner to help investigate individual specimens with delta check flags. For example, current and previous BMP and perhaps other results, for example, cholesterol and enzymes from the CMP, would be entered manually or the software would import the previous data. This data is accepted 28 From the optimized multivariate, delta check and other data that may be available (enzymes, cholesterol), calculate and report the likelihood that the sample is misidentified. The likelihood is from the likelihood ratio=sensitivity/(1−specificity) and is the slope of the ROC curve at a point represented by the multivariate delta. Once an initial data set has been input and analyzed, all of the statistical information is available to judge the likelihood that two new sets of results are from the same person.

The method and software support both automatically analyzing a set of patient data to optimize the delta check parameters that are input to the multivariate delta check equation; and investigating future samples with delta check flags using the statistical parameters from the MDC analysis and other information such as results of other tests, e.g., enzymes or cholesterol, and covariation of BUN and Crea, calculated results, e.g., BUN/Crea ratio, anion gap, calculated osmolality.

Preferred software provides an interactive interface that allows a user to set a number of flags that can be handled per a predetermined time period, and automatically adjusts the delta threshold to that number of flags. The software accepts BMP or other laboratory results from an output file from the LIS, or from manual input. These results are assumed to be correctly identified and free of interferences and contamination. Next, it generates a set of misidentified samples by intentionally pairing results from two different patients. Additionally, for each analyte individually, the program determines which delta check type (absolute change, percent change, rate of absolute change, or rate of percent change) best differentiates correctly identified and misidentified samples for that analyte. The software uses the optimum delta check type for each analyte and calculates the sensitivity, specificity and efficiency for each analyte alone and in all possible combinations. An interactive display is provided, e.g., as a table of the most efficient delta check combinations along with a comparison to the laboratory's current delta-check system. Furthermore the software automatically adjusts the delta threshold to achieve the maximum number of flags the laboratory can handle in a predetermined time period (e.g., per day or per shift).

From the known effects of specimen quality issues like hemolysis, icterus, and lipemia and the known effects of specimen contamination with IV fluids, such as physiological saline or Ringer's lactate, the II is used to calculate and report 32 the likelihood that one of these specimen quality problems is the cause of the delta check flags.

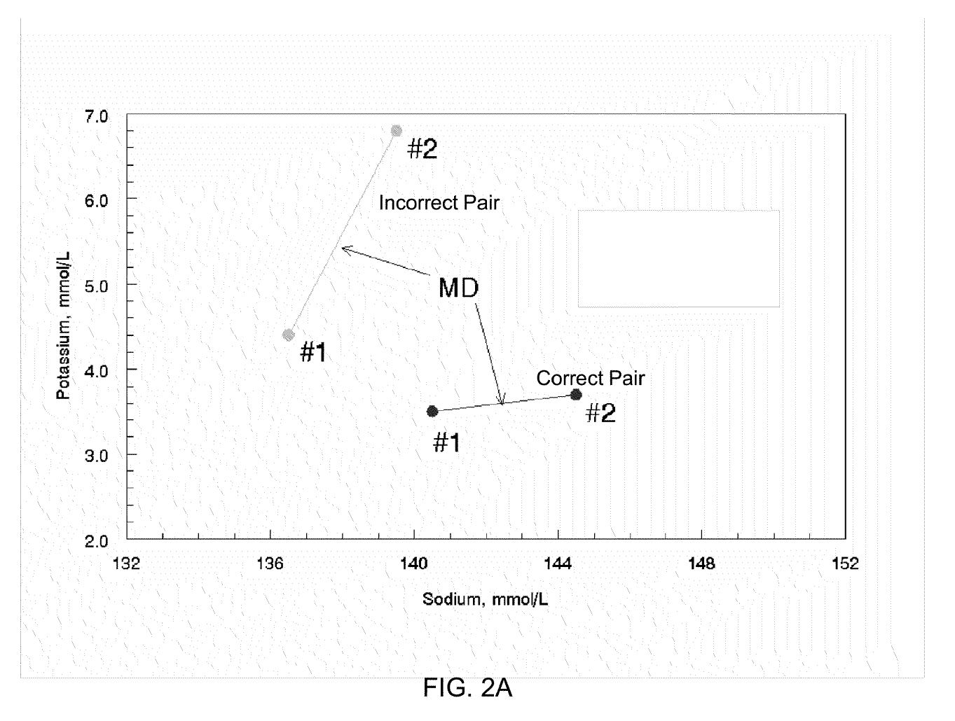

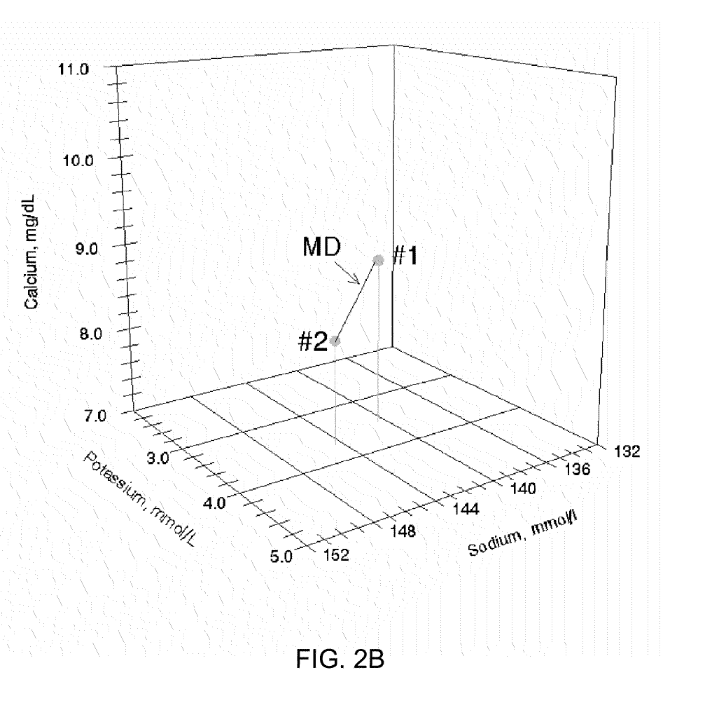

With the use of multivariate data as in the FIG. 1 method, with the data being specific to a laboratory or concern, which can reduce false flags. FIGS. 2A and 2B graphically illustrate the multivariate check, which considers several analyte values in a single equation to determine a delta check value. In FIG. 2A, the two analytes considered simultaneously are K and Na. If the multivariate DCL is greater than the length of line between the correct pair, the second sample of that pair will not be flagged. If the multivariate DCL is less than the length of line between the incorrect pair, the second sample of that pair will be flagged. FIG. 2B illustrates three results (Na, K, and Ca) from two samples plotted in three dimensions. The multivariate delta is the length of the line MD.

Data Sets and Testing

An example data set is provided in Table 1 below. The mismatch of 16 can be explained with respect to the data in Table 1. Table 1 below illustrates, for example, the change in BUN in patient RW650 is 21−25=−4, and so forth, but the change in BUN between the first sample of patient MH188 and the second sample of patient RW650 is 9−21=−12. In this case, the change in BUN is much larger for mismatched samples than it is for correctly matched samples. At a DCL of ±10 for BUN, the properly identified second sample from RW650 would not be flagged, but the misidentified first sample from MH188 would be flagged as possibly not belonging to patient RW650.

TABLE 1

| ID_Code | ColDT | BUN | CA | CL | CREA | GLU | K+ | NA | TCO2 |
|---|---|---|---|---|---|---|---|---|---|
| RW650 | 11/12/11 4:55 AM | 25 | 8.9 | 112 | 0.6 | 36 | 3.5 | 140 | 22 |
| RW650 | 11/13/11 2:00 AM | 21 | 8.2 | 117 | 0.6 | 100 | 3.7 | 144 | 18 |
| MH188 | 11/28/11 4:20 AM | 9 | 7.5 | 111 | 0.6 | 86 | 3.4 | 143 | 25 |
| MH188 | 11/29/11 5:40 AM | 5 | 8.0 | 113 | 0.5 | 89 | 3.9 | 142 | 23 |
| GH110 | 11/6/11 11:15 AM | 24 | 9.6 | 102 | 0.8 | 132 | 4.6 | 143 | 26 |
| GH110 | 11/9/11 2:30 AM | 36 | 9.4 | 102 | 0.9 | 156 | 4.1 | 144 | 32 |

This example considers the absolute change in results. The percent change in BUN for patient RW650 is 100×(21−25)/25 or −16%. The absolute change in BUN (−4) and the percent change (−16%) can each be divided by the time interval between 11/13/11 2:00 AM and 11/12/11 4:55 AM or 21.1 hours. Thus, the rate of absolute change is −4/21.1 hr=0.19 per hour and the rate of percent change is −16%/21.1 hr=0.76% per hour. The performance for these other ways to express the change can be calculated as was done for the absolute change above. For some analytes, one of these other change expressions may perform better.

Typically, the change in two results from the same patient would not be flagged (a negative result of Delta Checking) and the Delta Check result would be considered a True Negative (TN), but sometimes the change in results from a properly identified sample would exceed the DCL (a user set or predetermined level for a type of test), the Delta Check flag would be set (a positive result of Delta Checking) and the Delta Check result would be considered a False Positive (FP). Often the change in two results from two different patients would exceed the DCL, the Delta Check flag would be set (a positive result) and the Delta Check result would be a True Positive (TP). Sometimes the change in two results from two different patients would not exceed the DCL (a negative result) and the Delta Check result would be a False Negative (FN).

In preferred embodiments, a data set is developed for a specific institution because each hospital or medical center has a unique population. To develop a data set, the number of TN, FP, TP and FN results is counted for a large number of matched and mismatched results for each analyte. The sensitivity (SENS) is TP/(TP+FN), the specificity (SPEC) is TN/(TN+FP), efficiency (EFF) is the average of SENS and SPEC, the predictive value of a positive test (PV+) is TP/(TP+FP), the predictive value of a negative test (PV−) is TN/(TN+FN), the likelihood ratio of a positive test (LR+) is SENS/(1-SPEC), and the likelihood ratio of a negative test (LR−) is (1-SENS)/SPEC. The value of likelihood ratios is that the LR for two or more different tests can be multiplied to get the LR for the combination of the tests.

This analysis is repeated for each analyte using each of the four types of delta (absolute, percent, and their rates) 18 to determine the best delta type for each analyte and the DCL of that type that meets the user's specifications for sensitivity, specificity, number of positive flags per day, etc. The next step 20 analyzes the various combinations of tests using the optimum delta check type and DCL just determined. For the 8 analytes on a BMP there are 255 combinations, 8 of which are single tests. For each combination the multivariate DCL is calculated from the traditional (univariate) DCLs. Note that the multivariate procedure requires at least two analytes and there are 247 combinations of two or more analytes.

Then the 5 best combinations of analytes along with their delta type, DCL, the multivariate DCL, sensitivity, specificity, and other statistical parameters are presented to the user in a table 22. Next the effect of changing the maximum time interval is determined 24 and finally lab specific Delta Check parameters, both univariate and multivariate, are presented 26. In this example, 5 combinations were chosen. Each optimization entry includes quite a few pieces of information and the output table would likely be considered unwieldy with more than 5 choices, though more than 5 choices can be used. The first entry would be the best option as automatically determined, and this alone or this and one other would also be sufficient. The 5 top combinations are not necessary, but are chosen as an example.

The DCL can also be adjusted over time by the software, such as via a learning algorithm that adjusts according to parameters as a data set grows.

Patient Population Based CVi, CVg, and II

With a program conducting the method of FIG. 1, analyzing patient data from one tertiary care hospital, the intraindividual coefficient of variation (CVi) and the interindividual (or group) coefficient of variation (CVg) were calculated and divided CVi by CVg to get the index of individuality (II). The values determined through the method of FIG. 1 is compared to some literature values for analytes in Table 2. The difference between II in the literature and the II calculated from patient results shows the importance of analysis using laboratory/hospital specific patient data.

TABLE 2

| Analyte | II from literature | II from our population |
|---|---|---|
| Sodium (Na) | 0.70 | 0.40 |
| Potassium (K) | 0.86 | 0.45 |
| Chloride (Cl) | 0.80 | 0.33 |
| Carbon Dioxide (CO2) | 1.02 | 0.39 |
| Glucose (Glu) | 0.83 | 0.32 |
| Blood Urea Nitrogen (BUN) | 0.67 | 0.25 |
| Creatinine (Crea) | 0.37 | 0.08 |
| Calcium (Ca) | 0.68 | 0.39 |

The lower the II, the better the analyte will perform differentiating two samples from the same individual from two samples from different individuals. From the II in the literature one would conclude that the 3 best analytes to include in a Delta Checking procedure would be Crea, BUN, and Ca. Calculations from the population used in the testing shows that the best 3 analytes to include would be Crea, BUN, and Glu. This indicates that the II are different in the test population as compared to published values. The II calculated from other populations is likely to be different and, therefore, the analytes to include for optimum performance of delta check procedures are potentially specific for each laboratory's patient population. Software of the present invention can quickly isolate the critical parameters to be used for efficient Delta Check of samples.

The University of Louisville Hospital, at the time of filing of the provisional application from which this application has priority uses a traditional (multi-analyte univariate) Delta Check procedure using BUN (DCL, 10), Ca (1.5), Crea (1.5), K (1.2), and Na (8). With a Delta Check Utility Computer Program conducting the method of FIG. 1, the SENS and SPEC (and other calculations) of this set of parameters can be determined and the overall performance of Delta Checking to best suit the laboratory's needs. For example, the DCLs could be specified to give a desired level of SENS (0.9 in the example in the table) or to give a desired level of SPEC (0.9 in the example). This is shown in Table 3.

TABLE 3

| Adjustment | BUN | Ca | Crea | K | Na | SENS | SPEC |
|---|---|---|---|---|---|---|---|
| Current DCL | 10 | 1.5 | 1.5 | 1.2 | 8 | 0.573 | 0.862 |
| Adj. Analyte DCL for | 6 | 0.8 | 0.7 | 0.7 | 3 | 0.899 | 0.506 |
| SENS = ~0.9 | | | | | | | |
| Adj. Analyte DCL for | 11 | 1.8 | 1.7 | 1.4 | 10 | 0.465 | 0.90 |
| SPEC = ~0.9 | | | | | | | |

Increasing the SENS to detect more mislabeled samples is at the expense of SPEC (more correctly labeled samples will be flagged). Conversely, is increasing the SPEC to reduce falsely flagging correctly labeled samples is at the expense of SENS (fewer mislabeled samples will be flagged). Users can easily selected the desired way to adjust, which would depend on the laboratory's needs.

The FIG. 1 Multivariate Delta Check procedure was tested, using all eight analytes on the BMP and results from a patient population, MDC8. Two MDCs with fewer analytes were also analyzed. MDC7 excludes Glu and MDC5 includes the 5 analytes on the current multi-analyte univariate Delta Check procedure used by University of Louisville Hospital BUN, Ca, Crea, K, and Na. These results in the following tables used the MD equation normalized for the standard deviation of the reference range. When comparing different methods, it is helpful to compare them all at the same SENS or all at the same SPEC.

The analyte composition of the MDCs use in testing is show in Table 4.

TABLE 4

| MDC | Analytes |
|---|---|
| MDC8 | K, Na, Cl, CO₂, BUN, Crea, Glu, Ca |
| MDC7 | K, Na, Cl, CO₂, BUN, Crea, Ca |
| MDC5 | K, Na, BUN, Crea, Ca |

Table 5 shows the SENS for these three MDC at the SPEC for the multi-analyte Univariate procedure that is used at the UL Hospital.

TABLE 5
Comparison at the SPEC of the Multi-analyte Univariate Procedure

| Delta Check Procedure | SENS | SPEC |
|---|---|---|
| Current procedure | 0.573 | 0.862 |
| MDC8 | 0.545 | 0.862 |
| MDC7 | 0.671 | 0.862 |
| MDC5 | 0.656 | 0.862 |

At the SPEC of the current procedure, MDC8 is not as sensitive, MDC7 is more sensitive and MDC5 is slightly less sensitive than MDC7 and better than the current procedure

Table 6 shows the SPEC for the MDC at the SENS for the multi-analyte univariate procedure that is used at the UL Hospital.

TABLE 6
Comparison at the SENS of the Multi-analyte Univariate Procedure

| Delta Check Procedure | % SENS | SPEC |
|---|---|---|
| Current procedure | 0.573 | 0.862 |
| MDC8 | 0.573 | 0.853 |
| MDC7 | 0.573 | 0.897 |
| MDC5 | 0.573 | 0.886 |

At the SENS of the current procedure, the SPEC of MDC8 is approximately equivalent to the current procedure, but MDC7 and MDC5 are significantly more specific.

We also compared the ability of the current procedure and the MDC procedures to detect contamination with “Normal Saline” (NS: isotonic, 0.9%, Na and Cl concentration 154 mmol/L) and Ringer's Lactate (RL: Na, 130 mmol/L; CI, 109 mmol/L; K, 4 mmol/L). This is summarized in Table 7.

TABLE 7

| Delta Check Procedure | % NS detectable | % RL detectable |
|---|---|---|
| Current procedure | 16 | 16 |
| MDC8 | 22 | 30 |
| MDC7 | 15 | 24 |
| MDC5 | 12 | 22 |

MDC7 and MDC5 are equal or better at detecting Normal Saline contamination compared to the current procedure.

To evaluate the covariation of BUN and Crea covariation (both change in the same direction) was considered “true” if they both changed in the same direction or if either one of them did not change. Covariation was considered “false” if they changed in opposite direction. The same analysis was performed for the covariation of Na and Cl. Based on the results of 1035 matched and mismatched pairs of result from our laboratory the following likelihood ratios were found. The results are summarized in Table 8

TABLE 8

| Covariants | LR+ | LR− |
|---|---|---|
| BUN and Crea | 1.45 | 0.92 |
| Na and K | 1.09 | 0.98 |

These are not strongly correlated, but combination of this covariation test with univariate or multivariate Delta Checks by multiplication of the likelihood ratios adds to the overall improvement in Delta Checking performance.

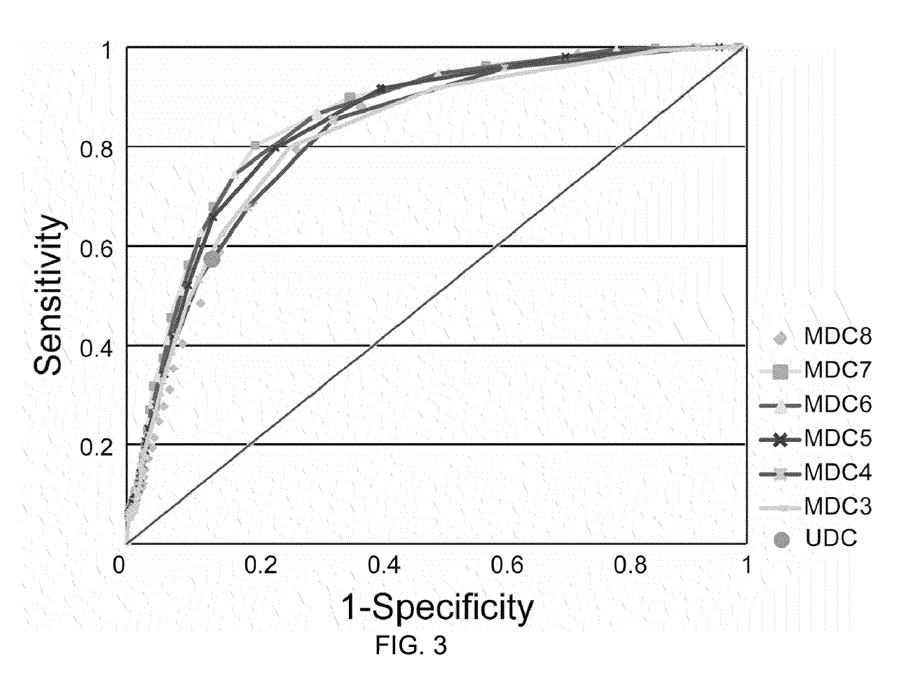

In the tests, the MD was calculated for 1035 correct identified pairs of patient results from our laboratory on a BMP (Na, K, Cl, CO₂, Glu, BUN, Crea, Ca) and for 1034 pairs of intentionally misidentified BMP results. FIG. 3 plots receiver-operating characteristic curves (ROC) that were based upon sensitivity and specificity. The figure shows ROC curves for each MDC with the points on each curve representing varying multivariate DCL. The closer a curve is to the upper left hand corner, that is, the greater the area under the ROC curve, the better the procedure. The current univariate delta check procedure (UDC) at the UL Hospital is represented by a single point since the DCL are fixed. Table 9 is the sensitivity of each procedure at the specificity of the current UDC. Table 10 is the specificity of each procedure at the sensitivity of UDC.

TABLE 9

| | UDC | MDC3 | MDC4 | MDC5 | MDC6 | MDC7 | MDC8 |
|---|---|---|---|---|---|---|---|
| True | 892 | 892 | 892 | 892 | 892 | 892 | 892 |
| Nega- | | | | | | | |
| tive | | | | | | | |
| False | 143 | 143 | 143 | 143 | 143 | 143 | 143 |
| Positive | | | | | | | |
| False | 442 | 428 | 373 | 345 | 341 | 479 | 471 |
| Nega- | | | | | | | |
| tive | | | | | | | |
| True | 593 | 606 | 661 | 689 | 693 | 555 | 563 |
| Positive | | | | | | | |
| Sensi- | 57.3 | 58.6 | 64 | 66.6 | 67 | 53.6 | 54.5 |
| tivity | | | | | | | |
| in % | | | | | | | |
| Speci- | 86.2 | 86.2 | 86.2 | 86.2 | 86.2 | 86.2 | 86.2 |
| ficity | | | | | | | |
| in % | | | | | | | |
| Effi- | 71.7 | 72.4 | 75.1 | 76.4 | 76.6 | 69.9 | 70.3 |
| ciency | | | | | | | |
| in % | | | | | | | |
| PPV | 81 | 81 | 82 | 83 | 83 | 80 | 80 |
| in % | | | | | | | |
| NPV | 67 | 68 | 71 | 72 | 72 | 65 | 65 |
| in % | | | | | | | |
| cut-off | | 4.266 | 4.760 | 5.330 | 5.773 | 8.255 | 8.411 |

TABLE 10

| | UDC | MDC3 | MDC4 | MDC5 | MDC6 | MDC7 | MDC8 |
|---|---|---|---|---|---|---|---|
| True | 892 | 898 | 918 | 927 | 928 | 879 | 883 |
| Nega- | | | | | | | |
| tive | | | | | | | |
| False | 143 | 137 | 117 | 108 | 107 | 156 | 152 |
| Positive | | | | | | | |
| False | 442 | 442 | 442 | 442 | 442 | 442 | 442 |
| Nega- | | | | | | | |
| tive | | | | | | | |
| True | 593 | 592 | 592 | 592 | 592 | 592 | 592 |
| Positive | | | | | | | |
| Sensi- | 57.3 | 57.3 | 57.3 | 57.3 | 57.3 | 57.3 | 57.3 |
| tivity | | | | | | | |
| in % | | | | | | | |
| Speci- | 86.2 | 86.7 | 88.7 | 89.6 | 89.7 | 84.9 | 85.3 |
| ficity | | | | | | | |
| in % | | | | | | | |
| Effi- | 71.7 | 72 | 73 | 73.5 | 73.5 | 71.1 | 71.3 |
| ciency | | | | | | | |
| in % | | | | | | | |
| PPV | 81 | 81 | 83 | 85 | 85 | 79 | 80 |
| in % | | | | | | | |
| NPV | 67 | 67 | 68 | 68 | 68 | 67 | 67 |
| in % | | | | | | | |
| cut-off | | 5.360 | 5.254 | 6.140 | 6.634 | 7.886 | 8.130 |

The results show that, for a particular data set, by adjusting the number of analytes considered by Equation 2 through software checks (for example, testing analytes until a maximum value is reached) a substantial improvement can be realized compared to a univariate delta check. In the example data, MDC6 performed the best and improved sensitivity by 17% at the specificity of the UDC and improved specificity by 4% at the sensitivity of the UDC. Such improved specificity would decrease the time necessary for DC flag investigation at UL Hospital by 7 h per month assuming 10 minutes per investigation and decrease the number of recollections.

Artisans will appreciate that methods of the invention account for localized variation. The methods of the invention recognize and conduct an automatic delta check (after a set up period) that accounts for localized factors including, for example, degree of the disease and therefore the amount of variation (delta) are dependent on where the order was placed. Methods and software of the invention also account for different patient populations, which can be specific to a type of care provider (primary or tertiary care) and can also be specifically based on the ordering unit (intensive care unit or regular floor). Software of the invention permits a quick, intuitive and semi or fully automated configuration to such specific population data sets that can bring immediate enhanced specificity and sensitivity.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for delta checking biological sample, the method being executed by code on a nontransient medium, the code conducting steps comprising:
receiving biological sample data for at least two individual patients from a particular health source, the biological sample data including values for a plurality of analytes;
automatically determining the best analytes and recommended delta threshold in the plurality of analytes that differentiate between patients by quantifying changes for analytes in the data of individual patients and intentionally mismatching date from multiple patients;
outputting analyte rankings for use in a delta check.

2. The method of claim 1, wherein said outputting further comprises providing an interactive display to determine the number of flags that can be handled per a predetermined time period, and adjusts the delta threshold to limit negative results based upon the threshold to that number of flags.

3. The method of claim 1, further comprising using a predetermined number or user-selected number of analytes determined in said step of outputting and conduct a delta check using the corresponding delta thresholds determined in said step of automatically determining.

4. The method of claim 1, wherein the delta thresholds are determined from a localized multivariate delta check study of the particular health source of a set of data for a plurality of patients via a multivariate process that determines a set of analytes of the plurality of analytes based upon calculating multivariate delta values for each of the plurality of patients and also for mismatched data among the plurality of patients to determined the set of analytes that provides a predetermined amount of differentiation between patients.

5. The method of claim 1, further comprising evaluating additional biological sample data using a multivariate delta check with at least some of the analytes and delta thresholds determined in said step of determining.

6. The method of claim 5, wherein the predetermined amount of differentiation comprises the highest level of differentiation between patients.

7. The method of claim 5, further comprising permitting user input to evaluate the impact of changing the maximum time interval between the current and previous biological sample.

8. The method of claim 5, wherein the delta threshold is set during a set up procedure in which the code accepts data from the plurality of patients to determine the localized multivariate delta check threshold.

9. The method of claim 5, wherein the code further accepts input concerning the rate or volume of testing being conducted, and displays data to a user to permit the user to adjust calculated multivariate delta thresholds to achieve a desired number of delta flag events per time period, a desired level or specificity, a desired level of sensitivity, or a combination of those factors.

10. The method of claim 5, wherein the multivariate delta is calculated according to:
MD=\sqrt{(analyte1₂−analyte1₁)²+(analyte2₂−analyte2₁)²+ . . .}
where analyte1, analyte2, etc. are the results for several analytes on the same sample and subscripts 1 and 2 are the results on two consecutive samples from the same patient.

11. The method of claim 5, wherein the multivariate delta is calculated according to:
$$MD = \sqrt{\frac{{( analyte {1}_{2} - analyte {1}_{1} )}^{2}}{SD - {RR}_{1 }} + \frac{{( analyte {2}_{2} - analyte {2}_{1} )}^{2}}{SD - {RR}_{2}} + …}$$
where analyte1, analyte2, etc. are the results for several analytes on the same sample and subscripts 1 and 2 are the results on two consecutive samples from the same patient and SD-RR is the standard deviation of the reference range.

12. A method for delta checking biological sample, the method being executed by code on a nontransient medium, the code conducting steps comprising:
accepting analyte data for a plurality of samples, wherein the analyte data includes levels of a plurality of analytes;
calculating a multivariate delta (MD) for all analyte results provided and any desired subset of those analytes based on the following equation:
$$MD = \sqrt{{( analyte {1}_{2} - analyte {1}_{1} )}^{2} + {( analyte {2}_{2} - analyte {2}_{1} )}^{2} + …}$$
$$Or$$
$$MD = \sqrt{\frac{{( analyte {1}_{2} - analyte {1}_{1} )}^{2}}{SD - {RR}_{1}} + \frac{{( analyte {2}_{2} - analyte {2}_{1} )}^{2}}{SD - {RR}_{2 }} + …}$$
Where analyte1, analyte2, etc. are the results for several analytes on the same sample and subscripts 1 and 2 are the results on two consecutive samples from the same patient, and SD-RR is the standard deviation of the reference range

13. The method of claim 12, further comprising conducting a setup procedure to determine a multivariate delta check limit, wherein the setup procedure collects patient population specific data and then calculates multivariate data for individual patient samples and for intentionally mismatched patient samples to determine and select an appropriate number of analytes from the plurality of analytes.
